(19) United States
(12) Patent Application Publication
(10) Pub. No.: US 2017/0099787 A1
(43) Pub. Date: Apr. 13, 2017

(54) Mulch Collecting And Distributing Assembly

(71) Applicant: Donald Whitney, Hudson, NH (US)

(72) Inventor: Donald Whitney, Hudson, NH (US)

(21) Appl. No.: 14/881,692

(22) Filed: Oct. 13, 2015

(51) Int. Cl. A01G 13/02

(52) U.S. Cl. CPC A01G 13/0287; A01G 13/0262; Y10S 47/11

(57) ABSTRACT

A mulch collecting and distributing assembly includes a housing having a rear wall and a perimeter wall extending forward of the rear wall. The perimeter wall has a forward edge defining an access opening. The perimeter wall includes an upper wall and a lower wall. A plurality of teeth is attached to the lower wall and extends forward from the forward edge. Each of the teeth is arced upwardly from the lower wall. An upper handle is attached to the upper wall adjacent to the forward edge. A rear handle is attached to the rear wall adjacent to the upper wall. The rear wall has a support formed therein adjacent to the lower wall and extending outwardly away from the rear wall. The teeth and the forward edge are extendable into mulch to fill the interior with mulch.

### BACKGROUND OF THE DISCLOSURE

### Field of the Disclosure

The disclosure relates to mulch spreading devices and more particularly pertains to a new mulch spreading device for assisting a person in collecting mulch from a mulch pile and distributing the mulch over an area requiring such.

### SUMMARY OF THE DISCLOSURE

An embodiment of the disclosure meets the needs presented above by generally comprising a housing having a rear wall and a perimeter wall extending forward of the rear wall to define an interior of the housing. The perimeter wall has a forward edge defining an access opening into the interior. The perimeter wall includes an upper wall, a lower wall, a first lateral wall and a second lateral wall. The interior has a volume equal to at least 1.0 cubic gallon. A plurality of teeth is attached to the lower wall and extends forward from the forward edge. Each of the teeth is arced upwardly from the lower wall. An upper handle is attached to the upper wall adjacent to the forward edge. A rear handle is attached to the rear wall adjacent to the upper wall. The rear wall has a support formed therein adjacent to the lower wall and extending outwardly away from the rear wall. The teeth and the forward edge are extendable into mulch to fill the interior with mulch.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a mulch collecting and distributing assembly according to an embodiment of the disclosure.

FIG. 2 is a rear perspective view of an embodiment of the disclosure.

FIG. 3 is a side view of an embodiment of the disclosure.

FIG. 4 is a bottom view of an embodiment of the disclosure.

FIG. 5 is a cross-sectional view of an embodiment of the disclosure taken along line 5-5 of FIG. 2.

### DESCRIPTION OF THE PREFERRED EMBODIMENT

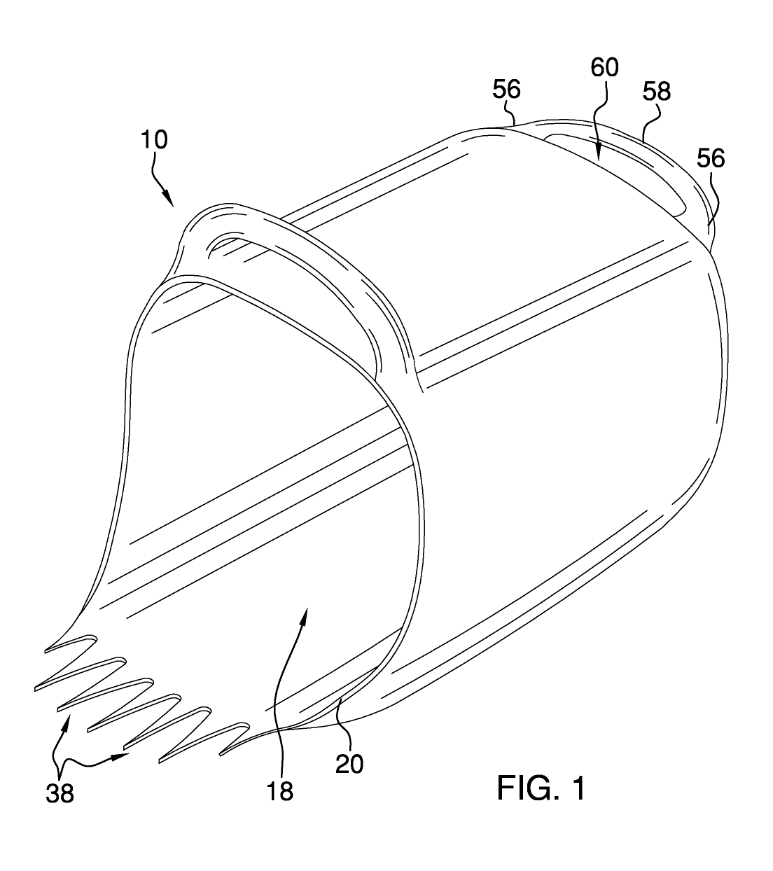

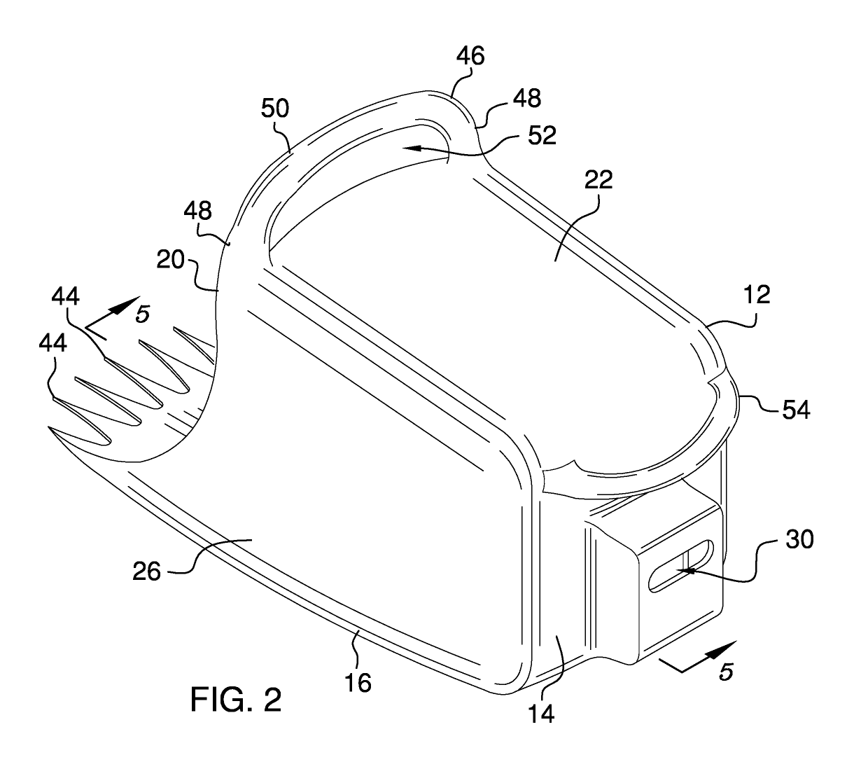

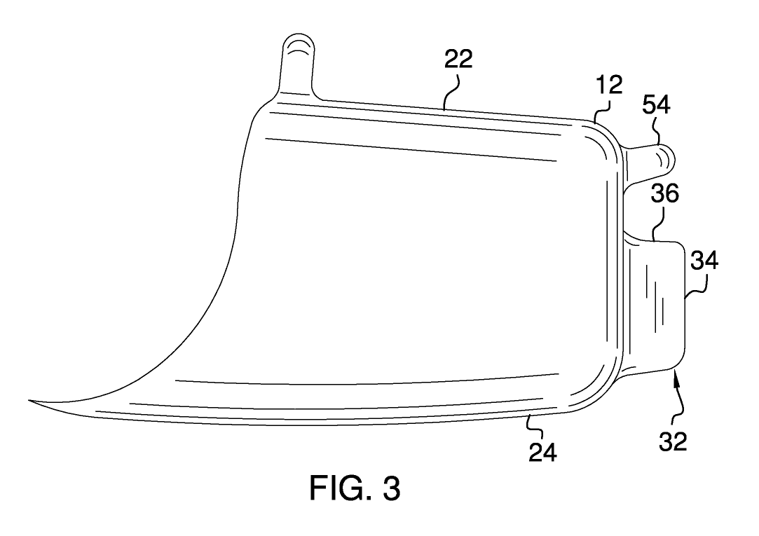

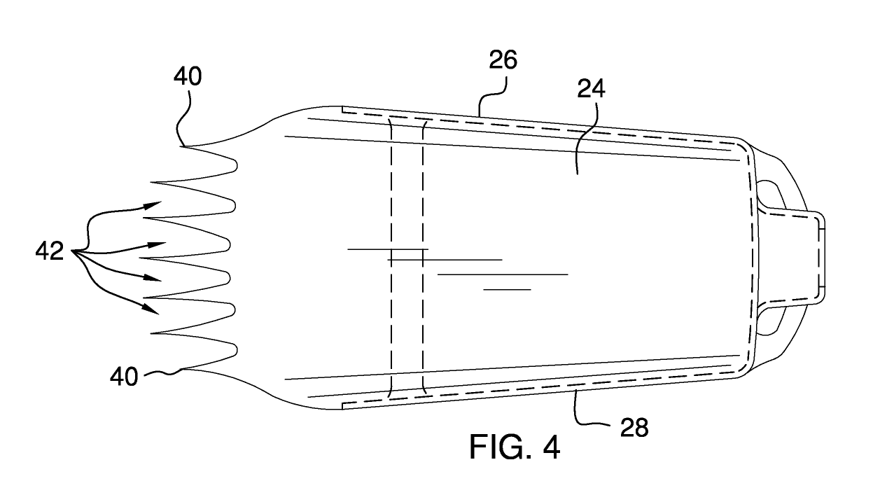

With reference now to the drawings, and in particular to FIGS. 1 through 5 thereof, a new mulch spreading device embodying the principles and concepts of an embodiment of the disclosure and generally designated by the reference numeral 10 will be described.

As best illustrated in FIGS. 1 through 5, the mulch collecting and distributing assembly 10 generally comprises a housing 12 that has a rear wall 14 and a perimeter wall 16 extending forward of the rear wall 14 to define an interior 18 of the housing 12. The perimeter wall 16 has a forward edge 20 defining an access opening into the interior 18. The perimeter wall 16 includes an upper wall 22, a lower wall 24, a first lateral wall 26 and a second lateral wall 28. Each of the upper 22 and lower 24 walls join the first 26 and second 28 lateral walls at rounded junctures. The perimeter wall 16 tapers outwardly from the rear wall 14 to the forward edge 20 and the interior 18 has a volume equal to at least 1.0 cubic gallon. The rear wall 14 has a hole 30 extending therethrough. The hole 30 may be spaced from the upper 22 and lower 24 walls and is configured to facilitate a release of air from the interior 18 when the interior is filled with mulch. The rear wall 14 has a support 32 formed therein adjacent to the lower wall 24 and extending outwardly away from the rear wall 14. The support 32 includes a distal wall 34 and a peripheral wall 36 that is attached to and extends between the distal wall 34 and the rear wall 14. The support 32 is hollow and in fluid communication with the interior 18. The hole 30 may be positioned in the distal wall 34.

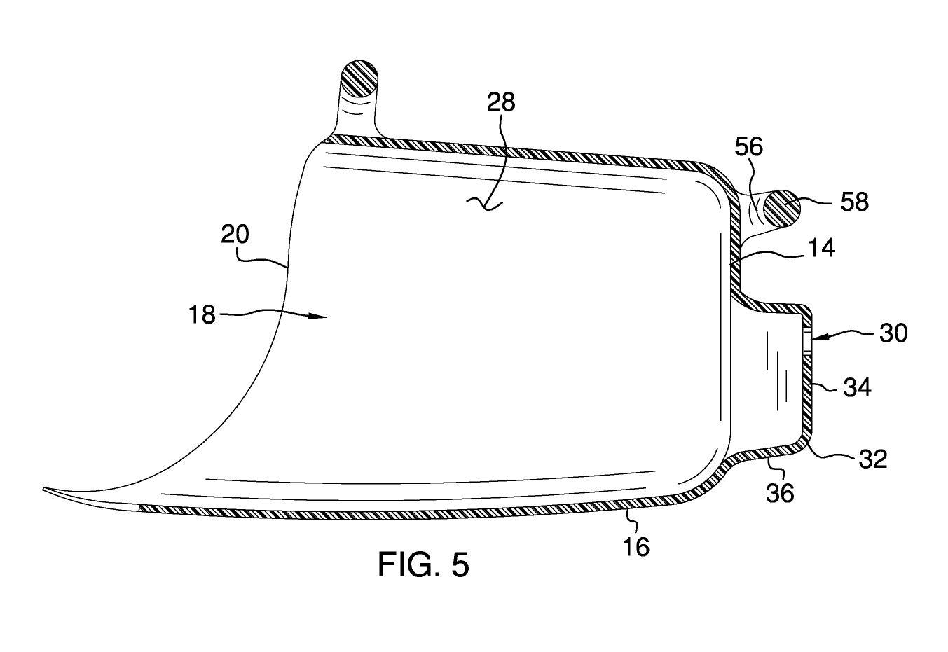

A plurality of teeth 38 is attached to the lower wall 24 and extends forward from the forward edge 20. Each of the teeth 38 is arced upwardly from the lower wall 24 as can best be seen in FIG. 5. This provides a better means of pulling material into the housing 12 when the housing 12 is tilted relative to mulch being collected. The plurality of teeth 38 includes a pair of outer teeth 40 and a plurality of inner teeth 42 positioned between the outer teeth 40. Each of the first 26 and second 28 lateral walls has one of the outer teeth 40 positioned adjacent thereto. The inner teeth 42 extend further away from the forward edge 20 than the outer teeth 40. There are typically at least 3 and up to 7 inner teeth 42. Each of the plurality of teeth 38 has a pointed terminal end 44 and each of the teeth 38 may be continuous with the lower wall 24 such that the teeth 38 are essentially formed from the bottom wall 24.

An upper handle 46 is attached to the upper wall 22 adjacent to the forward edge 20. The upper handle 46 includes a pair of legs 48 attached to the upper wall 22 and a center grip 50 is attached to and extends between the legs 48 such that an opening 52 is defined between the center grip 50 and the upper wall 22. Each of the first 24 and second 26 lateral walls has one of the legs 48 positioned adjacent thereto. A rear handle 54 is attached to the rear wall 14 adjacent to the upper wall 22. The rear handle 54 includes a pair of arms 56 attached to the rear wall 14 and a middle grip 58 is attached to and extends between the arms 56 such an aperture 60 is defined between the middle grip 58 and the rear wall 14. Each of the first 26 and second 28 lateral walls has one of the arms 56 positioned adjacent thereto. The support 32 extends farther from the rear wall 14 than the rear handle 54.

In use, the teeth 38 and the forward edge 20 are extendable into mulch to fill the interior 18 with mulch. The user may use the teeth 38 to break up the mulch to better loosen it as it is moved into the housing 12. The hole 30 in the rear wall 14, or support 32 therein, prevents air pockets from inhibiting the housing 12 from being completely filled with the mulch. The upper 46 and rear 58 handles are each gripped and the two handles 46, 58 allow a user to pivot the housing 12 within the mulch pile to cause the teeth 38 to lift up so that gravity causes the mulch to fall into the housing 12 while the support 32 may be abutted against the user's knees to act as a pivot or leverage point. Once filled, the user still grips both the upper 46 and rear 54 handles and shakes the housing 12 back and forth over an area requiring mulch so that the mulch is distributed evenly over the area.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A transfer container assembly configured for facilitating lifting and spreading of mulch, said assembly comprising:
a housing having a rear wall and a perimeter wall extending forward of said rear wall to define an interior of said housing, said perimeter wall having a forward edge defining an access opening into said interior, said perimeter wall including an upper wall, a lower wall, a first lateral wall and a second lateral wall, said interior having a volume equal to at least 1.0 cubic gallon;
a plurality of teeth being attached to said lower wall and extending forward from said forward edge, each of said teeth being arced upwardly from said lower wall;
an upper handle being attached to said upper wall adjacent to said forward edge;
a rear handle being attached to said rear wall adjacent to said upper wall;
said rear wall having a support formed therein adjacent to said lower wall and extending outwardly away from said rear wall; and
wherein said teeth and said forward edge are extendable into mulch to fill said interior with mulch.

2. The transfer container assembly according to claim 1, wherein each of said upper and lower walls joins said first and second lateral walls at rounded junctures, said perimeter wall tapering outwardly from said rear wall to said forward edge.

3. The transfer container assembly according to claim 1, wherein said plurality of teeth includes a pair of outer teeth and a plurality of inner teeth positioned between said outer teeth, each of said first an second lateral walls having one of said outer teeth positioned adjacent thereto, said inner teeth extending further away from said forward edge than said outer teeth.

4. The transfer container assembly according to claim 3, wherein each of said plurality of teeth has a pointed terminal end.

5. The transfer container assembly according to claim 1, wherein:
said upper handle includes a pair of legs attached to said upper wall and a center grip being attached to and extending between said legs such that an opening is defined between said center grip and said upper wall, each of said first and second lateral walls having one of said legs positioned adjacent thereto; and
said rear handle including a pair of arms attached to said rear wall and a middle grip being attached to and extending between said arms such an aperture is defined between said middle grip and said rear wall, each of said first and second lateral walls having one of said arms positioned adjacent thereto.

7. The transfer container assembly according to claim 1, wherein said rear wall having a hole extending therethrough, said hole being spaced from said upper and lower walls, said hole being configured to facilitate a release of air from said interior when said interior is filled with mulch.

8. The transfer container assembly according to claim 1, wherein said support includes a distal wall and a peripheral wall being attached to and extending between said distal wall and said rear wall, said support extending farther from said rear wall than said rear handle, said support being hollow and in fluid communication with said interior.

9. The transfer container assembly according to claim 8, wherein said rear wall having a hole extending therethrough, said hole being spaced from said upper and lower walls, said hole being configured to facilitate a release of air from said interior when said interior is filled with mulch, said hole being positioned in said distal wall.

10. A transfer container assembly configured for facilitating lifting and spreading of mulch, said assembly comprising:
a housing having a rear wall and a perimeter wall extending forward of said rear wall to define an interior of said housing, said perimeter wall having a forward edge defining an access opening into said interior, said perimeter wall including an upper wall, a lower wall, a first lateral wall and a second lateral wall, each of said upper and lower walls joining said first and second lateral walls at rounded junctures, said perimeter wall tapering outwardly from said rear wall to said forward edge, said interior having a volume equal to at least 1.0 cubic gallon;
a plurality of teeth being attached to said lower wall and extending forward from said forward edge, each of said teeth being arced upwardly from said lower wall, said plurality of teeth including a pair of outer teeth and a plurality of inner teeth positioned between said outer teeth, each of said first an second lateral walls having one of said outer teeth positioned adjacent thereto, said inner teeth extending further away from said forward edge than said outer teeth, each of said plurality of teeth having a pointed terminal end;
an upper handle being attached to said upper wall adjacent to said forward edge, said upper handle including a pair of legs attached to said upper wall and a center grip being attached to and extending between said legs such that an opening is defined between said center grip and said upper wall, each of said first and second lateral walls having one of said legs positioned adjacent thereto;
a rear handle being attached to said rear wall adjacent to said upper wall, said rear handle including a pair of arms attached to said rear wall and a middle grip being attached to and extending between said arms such an aperture is defined between said middle grip and said rear wall, each of said first and second lateral walls having one of said arms positioned adjacent thereto;
said rear wall having a hole extending therethrough, said hole being spaced from said upper and lower walls, said hole being configured to facilitate a release of air from said interior when said interior is filled with mulch;
said rear wall having a support formed therein adjacent to said lower wall and extending outwardly away from said rear wall, said support including a distal wall and a peripheral wall being attached to and extending between said distal wall and said rear wall, said support extending farther from said rear wall than said rear handle, said support being hollow and in fluid communication with said interior, said hole being positioned in said distal wall; and
wherein said teeth and said forward edge are extendable into mulch to fill said interior with mulch.
